(19) United States
(12) Patent Application Publication
(10) Pub. No.: US 2011/0132413 A1
(43) Pub. Date: Jun. 9, 2011

(54) PORTABLE WASHING DEVICE

(76) Inventor: David Lee Gans, San Leandro, CA (US)

(21) Appl. No.: 12/631,631

(22) Filed: Dec. 4, 2009

(51) Int. Cl. B08B 3/00

(52) U.S. Cl. 134/117

(57) ABSTRACT

Herein is described a portable washing device comprising: a reservoir to contain washing fluid; a cart supporting the reservoir; a lid attached to the reservoir; a control unit attached to the lid; a fluid supply hose having a first end and a second end; a submersible pump within the reservoir, said pump attached to the first end of the fluid supply hose; and a washing head unit attached to the second end of the fluid supply hose where the washing head unit has a pressure sensor switch; wherein pressure from a washing motion causes the pressure sensor switch to activate the submersible pump thus delivering washing fluid to the washing head unit.

### BACKGROUND OF THE INVENTION

The present invention generally relates to a portable washing device. Users of vehicles desire to keep the vehicles clean without spending a long time doing hand washing. However, it is desirable to achieve the quality of cleaning possible with hand-washing.

As can be seen, there is a need for a device to facilitate an efficient hand washing process.

### SUMMARY OF THE INVENTION

In one aspect of the present invention, a portable washing device is described comprising: a reservoir to contain washing fluid; a cart supporting the reservoir; a lid attached to the reservoir; a control unit attached to the lid; a fluid supply hose having a first end and a second end; a submersible pump within the reservoir, said pump attached to the first end of the fluid supply hose; and a washing head unit attached to the second end of the fluid supply hose where the washing head unit has a pressure sensor switch; wherein pressure from a washing motion causes the pressure sensor switch to activate the submersible pump thus delivering washing fluid to the washing head unit.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the invention;

FIG. 2: is a cross-sectional view of an exemplary embodiment of the invention, taken on line 2-2 of FIG. 1;

FIG. 3 is a cross- sectional view of an exemplary embodiment of the invention, taken on line 3-3 of FIG. 1;

FIG. 4 is a cross-sectional view of an exemplary embodiment of the invention, similar to FIG. 3 illustrating release of the soap and water solution.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a portable washing device suitable for washing, for example, vehicles.

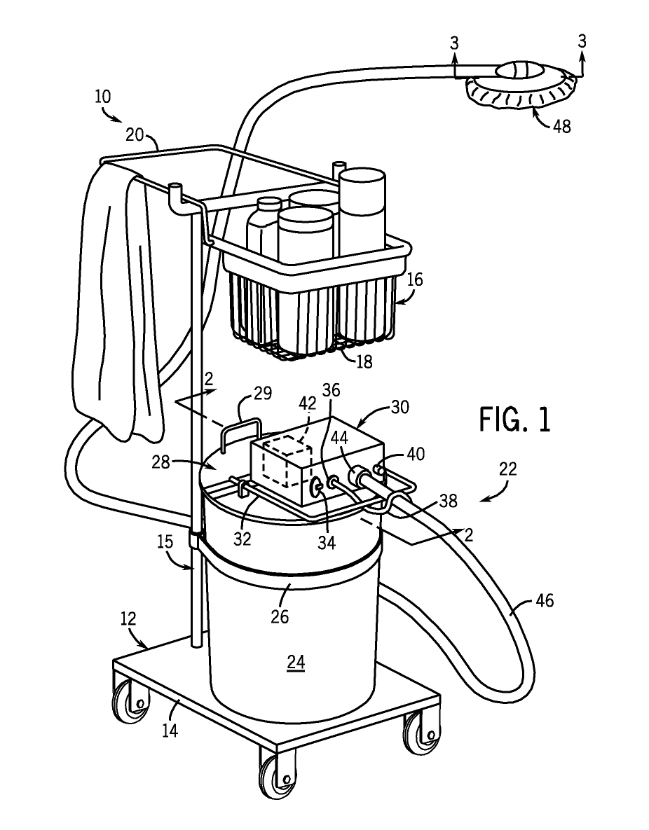

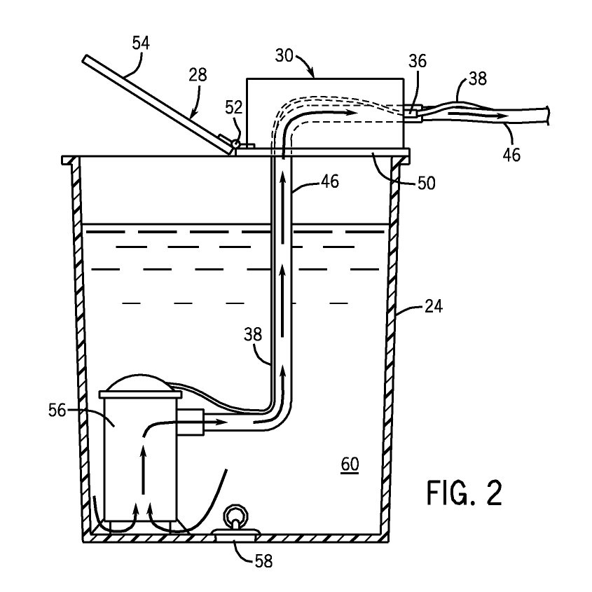

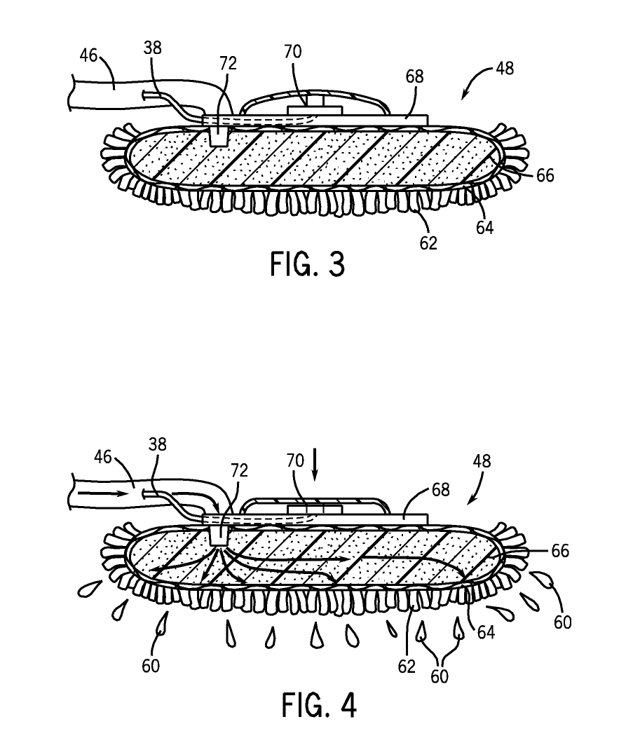

FIGS. 1-4 illustrate an exemplary embodiment of the invention 10. A reservoir is supported on the base 14 of a cart 12. A vertical support 15 is attached to the cart 12 and supports the upper unit 16 of the cart 12. The upper unit 16 has a supply shelf 18 to hold supplies or other items. The upper unit 16 also has a towel rack 20. The vertical support 15 also supports a restraining band 26 that secures a reservoir unit 22 on the cart base 14. A fluid supply hose 46 is used to transfer fluid such as a soap water solution 60 from the reservoir 24 to the washing head unit 48. A pressure sensor switch 70 is housed inside the washing head unit 48 (see FIGS. 3-4). The pressure sensor switch 70 is a normally open dual point contact switch. This pressure sensor switch 70 becomes closed when pressure is applied. The pressure sensor switch 70 is waterproof. A submersible pump 56 (see FIG. 2) typically operates at twelve volts and is used to supply fluid to the fluid supply hose 46. The submersible pump 56 is activated by the pressure sensor switch 70. A control cable 38 runs from the submersible pump 56, along the fluid supply hose 46 (for support), through the non-pivoting portion of the lid 50 and into the control unit 30. The control cable 38 exits the control unit 30 through the control cable port 36 (see FIG. 2), and connects to the pressure sensor switch 70 (see FIG. 3). A twelve volt battery 42 can be used to power the submersible pump 56. A reservoir unit 22 contains the fluid for submersing the submersible pump 56, and the reservoir unit 22 is used to attach the mounting bracket 32 of the control unit 30. The control unit 30 contains the outlets used to operate the portable washing device 10. The control unit 30 has an on/off switch 34 that provides power to the pressure sensor switch 70. The connection is made by a twelve volt flat female jack. The control unit 30 also has a hose coupling connection 44 for connecting the fluid supply hose 46. The control unit 30 is equipped with a twelve volt fuse receptacle 40 for safety in the event of a short circuit. The control unit 30 has an internal compartment for a battery 42 and has a twelve volt flat female jack for recharging the battery 42.

In order to use the device, fill the reservoir 24 with water and a suitable washing solution using the handle 29 to open the pivoting part 50 of the hinged lid 28 provided on top of reservoir 24. Connect the fluid supply hose 46 to the control unit 30 mounted on top of the lid 28. Plug in the power cord that is attached to the fluid supply hose 46 into the power outlet jack mounted on control unit 30. Install the washing pad to complete the washing head unit 48. The washing pad comprises an open-cell foam rubber core 66 covered by a cloth covering 64 that is in turn covered by a mop head 62 (see FIG. 3). Turn the portable washing device 10 on using the on/off switch 34 mounted on the control unit 30. Position your hand onto the washing head unit 48 using an elastic strap. Contact the item to be washed using the washing pad and apply typical moderate pressure in a washing motion. With pressure applied to the washing pad the portable washing device 10 will automatically supply the washing pad with the soap water solution 60. The pressure sensor switch 70 in the washing head unit 48 detects the pressure applied by the hand in the washing motion and energizes the submersible pump 56 sending fluid through the fluid supply hose 46 to the washing pad on the washing head unit 48 where the fluid exits through a nozzle 72 (see FIG. 4). For cleanup, excess soap water solution 60 can be drained through a hole in the bottom of the reservoir 24 by removing plug 58.

In alternative embodiments the device can be made using different materials. In alternative uses the device can be used to wash windows, a dog, a boat, a jet-ski, etc.

It should be understood, of course, that the foregoing relates to exemplary embodiments of the invention and that modifications may be made without departing from the spirit and scope of the invention as set forth in the following claims.

We claim:

1. A portable washing device comprising:
a reservoir to contain washing fluid;
a cart supporting the reservoir;
a lid attached to the reservoir;
a control unit attached to the lid;
a fluid supply hose having a first end and a second end;
a submersible pump within the reservoir, said pump attached to the first end of the fluid supply hose; and
a washing head unit attached to the second end of the fluid supply hose where the washing head unit has a pressure sensor switch;
wherein pressure from a washing motion causes the pressure sensor switch to activate the submersible pump thus delivering washing fluid to the washing head unit.

2. The portable washing device of claim 1 further comprising:
a vertical support having a first end and a second end, where the first end of the vertical support is attached to the cart; and
an upper unit attached to the second end of the vertical support, said upper unit comprising a towel rack and a supply shelf.

3. The portable washing device of claim 1 further comprising:
a non-pivoting part of the lid;
a pivoting part of the lid; and
a hinge connecting the non-pivoting part and the pivoting part.

4. The portable washing device of claim 1 where the washing head unit further comprises:
an open-cell foam rubber core;
a cloth covering the core; and
a mop head covering the cloth.

5. The portable washing device of claim 1 wherein the device is battery powered.

6. The portable washing device of claim 3 wherein the control box is attached to the non-pivoting part of the lid.

7. The portable washing device of claim 3 further comprising:
a handle attached to the pivoting part of the lid.
